(19) United States
(12) Patent Application Publication
(10) Pub. No.: US 2019/0122476 A1
(43) Pub. Date: Apr. 25, 2019

(54) COIN BAR UNPACKING APPARATUS

(71) Applicant: TOSHIBA TEC KABUSHIKI KAISHA, Tokyo (JP)

(72) Inventors: Yuki KAWAGUCHI, Tagata Shizuoka (JP); Koichi HIRUTA, Mishima Shizuoka (JP); Naoaki IDE, Shizuoka Shizuoka (JP)

(21) Appl. No.: 16/114,144

(22) Filed: Aug. 27, 2018

(30) Foreign Application Priority Data
Oct. 25, 2017 (JP) 2017-205766

(51) Int. Cl. G07D 9/00; B65B 69/00

(52) U.S. Cl. CPC G07D 9/004; B65B 69/0033

(57) ABSTRACT

A coin bar unpacking apparatus comprises a housing including an opening and a hole configured to accommodate a packed coin bar inserted through the opening, the hole extending in an insertion direction of packed coin bar and decreasing in diameter along the insertion direction such that a first diameter of the hole at a first location is greater than a second diameter of the hole at a second location that is farther from the opening than the first location. An inner surface of the housing at the second location restricts movement of the packed coin bar in a first direction when the packed coin bar is pressed against a rim of the opening in a second direction that is opposite to the first direction.

### CROSS-REFERENCE TO RELATED APPLICATION

This application is based upon and claims the benefit of priority from Japanese Patent Application No. 2017-205766, filed in Oct. 25, 2017, the entire contents of which are incorporated herein by reference.

### FIELD

Embodiments described herein relate generally to a coin bar unpacking apparatus.

### BACKGROUND

Conventionally, in a retail store, a coin bar that is obtained by packing a plurality of coins of the same denomination in a bar or columnar shape is used for replenishment of changes. Since the coin bar is packed with a resin film or a paper, at the time of using the coins, it is necessary to break the package and unpack it. Therefore, for example, there is known an example in which the coin bar is unpacked by inserting the coin bar in a hole provided with a cutter and then tearing the film or paper using the cutter.

However, in such a coin bar unpacking apparatus, in order to keep the cutter sharp, it is necessary to periodically replace the cutter blade. In addition, since the cutter is used, there is a possibility of injury to a human body as a result of inadvertent contact with the cutter.

### DESCRIPTION OF THE DRAWINGS

FIG. 1(a) is a perspective view externally illustrating a coin bar unpacking apparatus according to a first embodiment, FIG. 1 (b) is a perspective view externally illustrating a state in which the coin bar is inserted into the coin bar unpacking apparatus, and FIG. 1(c) is a perspective view externally illustrating a state in which the coin bar is unpacked with the coin bar unpacking apparatus;

FIG. 2 is a cross-sectional view along XZ plane in which a part of the coin bar unpacking apparatus is cut at a substantially center of a hole according to the first embodiment;

FIG. 3(a)-3(c) are cross-sectional views along YZ plane illustrating an inner structure of the hole of the coin bar unpacking apparatus shown in FIG. 2, FIG. 3(a) is a cross-sectional view taken along a line A-A, FIG. 3(b) is a cross-sectional view taken along a line B-B, and FIG. 3(c) is a cross-sectional view taken along a line C-C;

FIG. 4 is a cross-sectional view along XZ plane of the coin bar unpacking apparatus in a state in which the coin bar is unpacked;

FIG. 5(a)-5(c) are cross-sectional views along XZ plane and YZ plane illustrating a modification of the hole of the coin bar unpacking apparatus according to the first embodiment;

FIG. 6(a) is a perspective view externally illustrating a coin bar unpacking apparatus according to a second embodiment, FIG. 6 (b) is a perspective view externally illustrating a state in which the coin bar is inserted into the coin bar unpacking apparatus, and FIG. 6(c) is a perspective view externally illustrating a state in which the coin bar is unpacked with the coin bar unpacking apparatus;

FIG. 7(a) is a perspective view externally illustrating a coin bar unpacking apparatus according to a third embodiment, FIG. 7(b) is a cross-sectional view along XZ plane of the coin bar unpacking apparatus, FIG. 7(c) is a perspective view externally illustrating a coin bar pressing frame;

FIG. 8(a) is a sectional view along YZ plane of the coin bar unpacking apparatus according to the third embodiment, and FIG. 8(b) is a cross-sectional view along XY plane of the coin bar unpacking apparatus according to the third embodiment; and

FIG. 9(a) is a cross-sectional view along XY plane illustrating an inserted state of a thinner coin bar to the coin bar unpacking apparatus according to the third embodiment, and FIG. 9(b) a cross-sectional view along XY plane illustrating an inserted state of a thicker coin bar to the coin bar unpacking apparatus according to the third embodiment.

### DETAILED DESCRIPTION

In accordance with an embodiment, a coin bar unpacking apparatus comprises a housing including an opening and a hole configured to accommodate a packed coin bar inserted through the opening, the hole extending in an insertion direction of packed coin bar and decreasing in diameter along the insertion direction such that a first diameter of the hole at a first location is greater than a second diameter of the hole at a second location that is farther from the opening than the first location. An inner surface of the housing at the second location restricts movement of the packed coin bar in a first direction when the packed coin bar is pressed against a rim of the opening in a second direction that is opposite to the first direction.

### First Embodiment

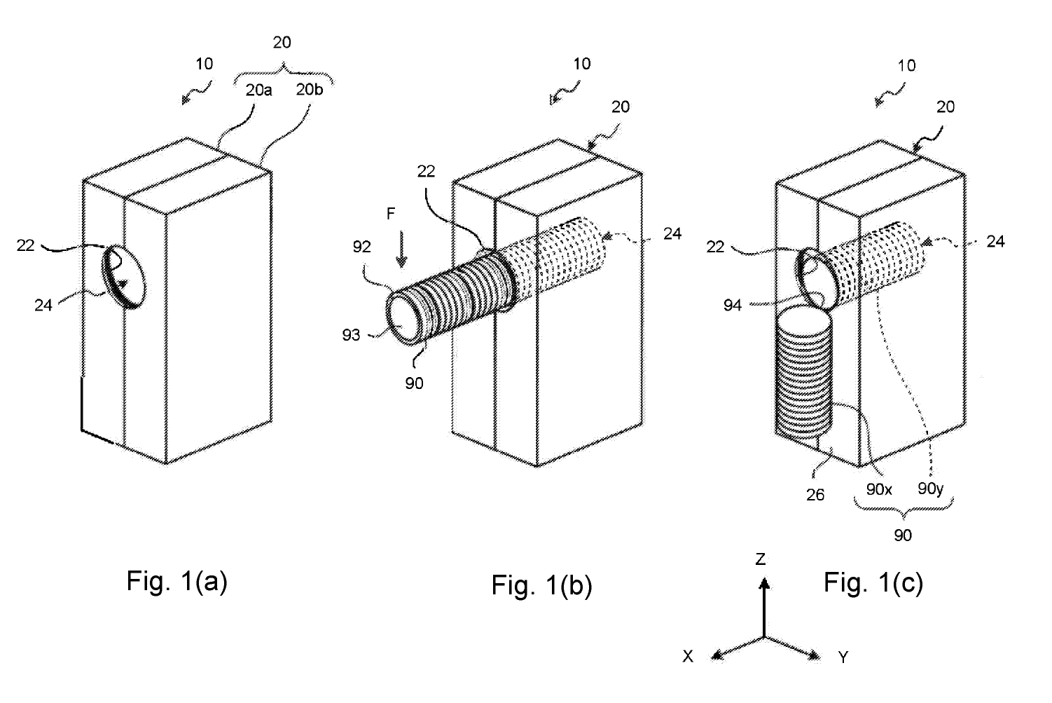

First, with reference to FIG. 1, a coin bar unpacking apparatus is described. FIG. 1(a) is a perspective view externally illustrating a coin bar unpacking apparatus 10, FIG. 1(b) is a perspective view externally illustrating a state in which a coin bar 90 is inserted into the coin bar unpacking apparatus 10, and FIG. 1(c) is a perspective view externally illustrating a state in which the coin bar 90 is unpacked with the coin bar unpacking apparatus 10.

(Description of Functions of the Coin Bar Unpacking Apparatus)

As shown in FIG. 1(a), the coin bar unpacking apparatus 10 has a hole 24 having an opening 22 in a substantially rectangular parallelepiped housing 20. The housing 20 is formed by joining a housing 20a and a housing 20b by bonding, screwing, or the like. The opening 22 is formed at a junction between the housing 20a and the housing 20b and has a shape (for example, a substantially circular shape) into which the coin bar 90 can be inserted. The hole 24 is formed from the opening 22 towards the inside of the housing 20 such that the coin bar 90 can be inserted to a depth corresponding to about half the length of the coin bar 90. The specific internal structure of the hole 24 is described later. For the sake of the following description, a XYZ coordinate system is set by setting a direction in which the hole 24 of the coin bar unpacking apparatus 10 extends as a X axis, a width direction of the coin bar unpacking apparatus 10 as a Y axis, and a height direction of the coin bar unpacking apparatus 10 as a Z axis.

As shown in FIG. 1 (b), the coin bar 90 can be inserted into the hole 24 continuous to the opening 22 of the housing 20. The coin bar 90 is obtained by stacking a plurality of coins 93 of the same denomination in a cylindrical shape and packaging them with a film 92. The coin bar 90 is generally formed by packing coins which may be currency, medals used in a game machine, etc. in a bar shape. In the present embodiment, for example, the coin bar 90 in which fifty coins 93 are stacked is described as an example.

With the coin bar 90 inserted into the hole 24, a pressing force in a Z axis negative direction that is substantially orthogonal to the direction of the bar shape 90, (i.e., a direction indicated by an arrow F) shown in FIG. 1 (b) is applied to one end of the coin bar 90 which is not inserted into the hole 24. Then, as shown in FIG. 1 (c), the film 92 packaging the coin bar 90 is unpacked at the opening 22 of the hole 24. Details of an unpacking mechanism are described later.

If the coin bar 90 is unpacked, the film 92 at a position on the Z axis negative side of the film 92 packaging the coin bar 90 remains partially uncut shown as a residual film part 94. In this way, the coin bar 90 is divided into a coin bar slice 90x hanging out of the housing 20 and a coin bar slice 90y left in the hole 24. The housing 20 has a colliding section 26 where the coin bar slice 90x collides. The colliding section 26 is formed so as to be substantially flush with the surface formed by the periphery of the opening 22, and the side surface of the coin bar slice 90x collides with the colliding section 26. In the example in FIG. 1(c), an outer peripheral surface of the housing 20, which is continuous to the periphery of the opening 22, becomes the colliding section 26. In order to unpack the film 92, it is preferable that the coin bar slice 90x and the coin bar slice 90y after unpacking form an angle of approximately 90 degrees. In other words, it is desirable that the insertion direction of the coin bar 90 and the surface where the colliding section 26 is formed form an angle of approximately 90 degrees therebetween.

An operator who unpacks the coin bar 90 takes out the coin bar slice 90x and the coin bar slice 90y from the housing 20 by gripping the coin bar slice 90x and pulling it out from the hole 24. Subsequently, the operator unpacks both the coin bar slice 90x and the coin bar slice 90y from the position of the residual film section 94 by pulling the coin bar slice 90x and the coin bar slice 90y to take out the coins.

(Description of Internal Structure of the Coin Bar Unpacking Apparatus)

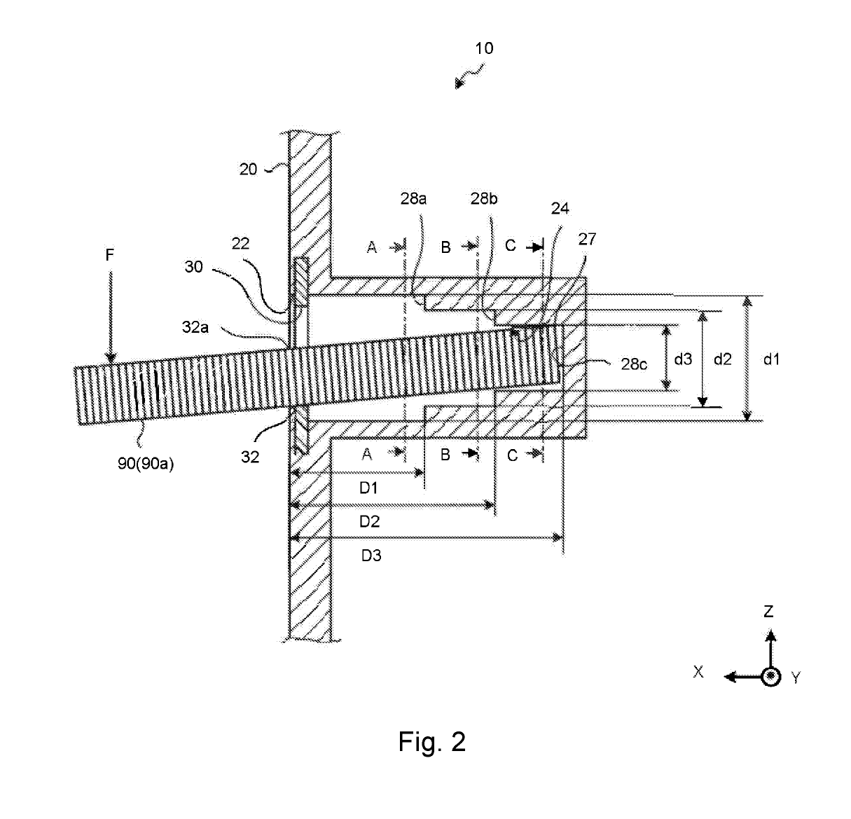

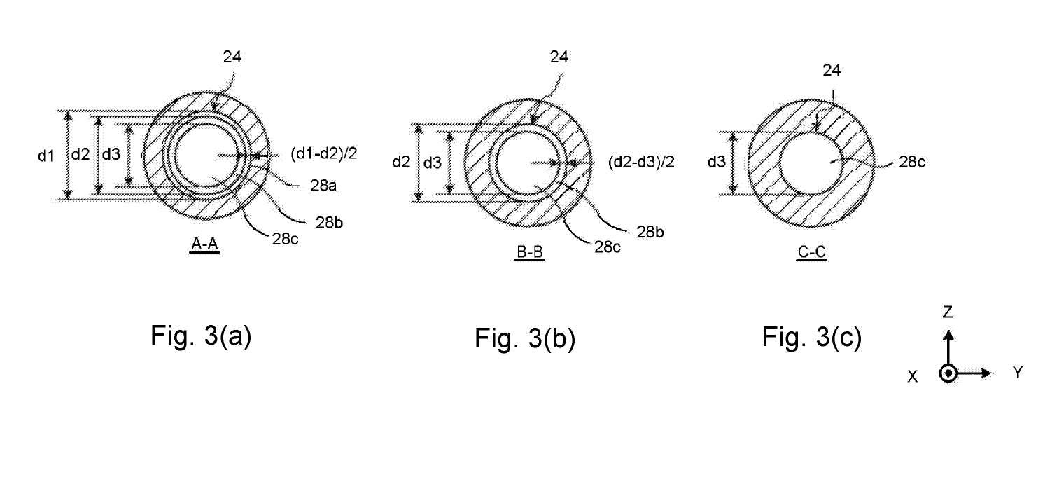

Next, the internal structure of the coin bar unpacking apparatus 10 is described with reference to FIG. 2 and FIG. 3. FIG. 2 is a cross-sectional view along XZ plane in which a part of the coin bar unpacking apparatus 10 is cut at a substantially center of the hole 24.

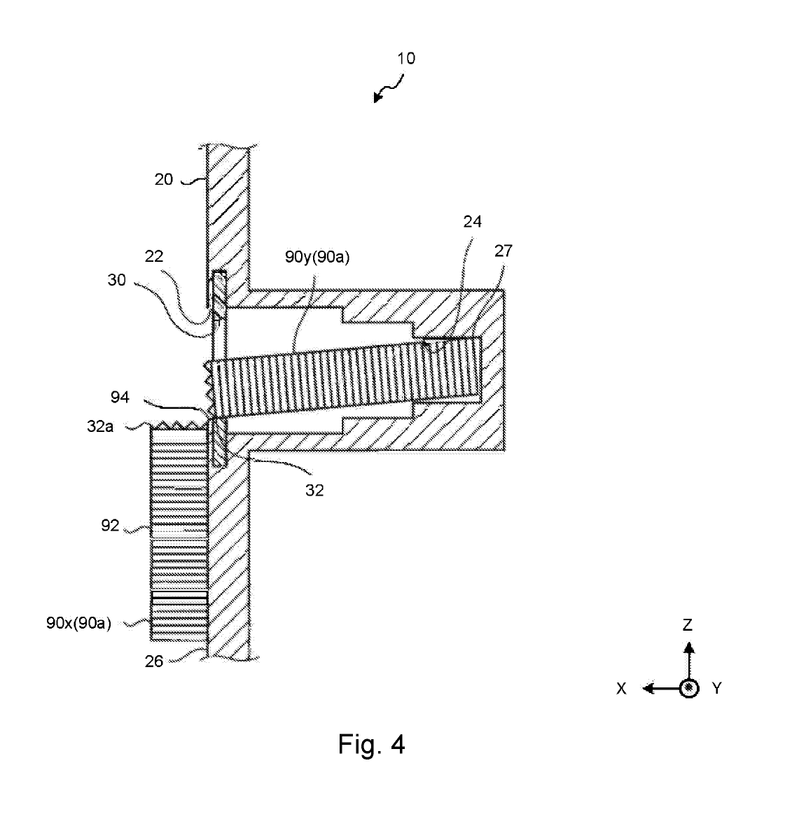

The hole 24 is formed continuous to the opening 22, has a depth corresponding to a coin bar 90a at which the coin bar 90a can be inserted, and has a diameter corresponding to the diameter of the coin bar 90a. In the coin bar unpacking apparatus 10 shown in FIG. 4, the hole 24 is formed in a substantially circular shape. In the hole 24, a first bottom 28a, a second bottom 28b, and a third bottom 28c are formed stepwise, respectively. The first bottom 28a is formed at a position corresponding to a depth D1 from the opening 22. The second bottom 28b is formed at a position corresponding to a depth D2 from the opening 22. The third bottom 28c is formed at a position corresponding to a depth D3 from the opening 22.

A diameter d1 of the first bottom 28a is set to, for example, d1=27 mm. A diameter d2 of the second bottom 28b is set to, for example, d2=24 mm. The diameter d3 of the third bottom 28c is set to, for example, d3=21.5 mm. In other words, the coin bar 90 having a diameter within the diameter d3 can be inserted to the position of the third bottom 28c. The coin bar 90 having a diameter between the diameter d2 and the diameter d3 (where d3<d2) can be inserted to the position of the second bottom 28b. The coin bar 90 having a diameter between the diameter d2 and the diameter d1 (where d2<d1) can be inserted to the position of the first bottom 28a.

For coins used in Japan, six types are used. The diameter of a 1 yen coin is 20.0 mm, the diameter of a 5 yen coin is 22.0 mm, the diameter of a 10 yen coin is 23.5 mm, the diameter of a 50 yen coin is 21.0 mm, the diameter of a 100 yen coin is 22.6 mm, and the diameter of a 500 yen coin is 26.5 mm. Then, the 1 yen coin and the 50 yen coin having small diameters can be inserted to the position of the third bottom 28c. The 5 yen coin, the 10 yen coin and the 100 yen coin having intermediate diameters can be inserted to the position of the second bottom 28b. Then, the 500 yen coin having a large diameter can be inserted to the position of the first bottom 28a. Hereinafter, for convenience of description, the coin bar 90 of the 1 yen coin and the coin bar 90 of the 50 yen coin are referred to as the coin bar 90a. The coin bar 90 of the 5 yen coin, the coin bar 90 of the 10 yen coin and the coin bar 90 of the 100 yen coin are referred to as a coin bar 90b (not shown). The coin bar 90 of the 500 yen coin is referred to as a coin bar 90c (not shown). FIG. 2 shows an example in which the coin bar 90a is inserted to the position of the third bottom 28c.

A depth D1 of the first bottom 28a, a depth D2 of the second bottom 28b and a depth D3 of the third bottom 28c are preferably set in such a manner that a length of a portion of the coin bar 90 which inserted into the hole 24 is substantially equal to that of a portion of the coin bar 90 which is not inserted into the hole 24 when the coin bar 90 is inserted to the back side of the hole 24. For example, it is set that D1=about 30 mm, D2=about 40 mm, D3=about 50 mm. By setting the depth D1, D2 and D3 of the hole 24 in this manner, the length of the portion of the coin bar 90 which is not inserted into the hole 24 is substantially half the length of the coin bar 90, and thus, when unpacking the coin bar 90, it is easier to apply a pressing force to the portion projecting from the housing 20, i.e., the side which is not inserted into the hole 24 of the coin bar 90.

In the vicinity of the opening 22, a wrapping member 30 having an opening area slightly narrower than that of the opening 22 is arranged. The wrapping member 30 is a plate-like member made of metal such as iron, for example.

In the state shown in FIG. 2, if the pressing force in the arrow F direction substantially orthogonal to the direction of the coin bar 90a is applied to the end of the coin bar 90a which is not inserted into the hole 24 while the coin bar 90a is in a state of being inserted into the hole 24, the coin bar 90a abuts against a wall surface of the hole 24 at an abutting section 27 in the vicinity of the third bottom 28c. In other words, the abutting section 27 is formed in the hole 24 and restricts movement of the coin bar 90a in a direction other than the insertion direction. Furthermore, as shown in FIG. 2, the coin bar 90a is abutting against the wrapping member 30 at a pressure reception section 32. In other words, the pressure reception section 32 is formed in the vicinity of the opening 22, and receives the pressing force in the direction substantially orthogonal to the direction of the coin bar 90a to one end, which is not inserted into the hole 24, of the coin bar 90a. The shape of the pressure reception section 32 is determined by the shape of the wrapping member 30. Specifically, the pressure reception section 32 may be abut against the outer surface of the coin bar 90a at one point, or the pressure reception section 32 may be abut against a part of an arc formed by the outer surface of the coin bar 90a in a curved manner.

Next, the sectional shape of the hole 24 is described with reference to FIG. 3. FIG. 3 is a cross-sectional view along the YZ plane illustrating the internal structure of the hole 24 of the coin bar unpacking apparatus 10 shown in FIG. 2, and FIG. 3(a) is a sectional view taken along a line A-A. FIG. 3(b) is a cross-sectional view taken along a line B-B. FIG. 3(c) is a cross-sectional view taken along a line C-C.

As shown in FIG. 3(a), in the hole 24, the first bottom 28a, the second bottom 28b, and the third bottom 28c are formed stepwise. The first bottom 28a is a region whose peripheral border has a width (d1−d2)/2 in the hole 24 having the diameter d1. The coin bar 90c (not shown) can be inserted to the position of the first bottom 28a. The region at the inner side of the first bottom 28a is formed into a substantially circular shape, and the region has an area at which the coin bar 90a (refer to FIG. 2) and the coin bar 90b (not shown) can pass.

As shown in FIG. 3(b), the second bottom 28b is a region whose peripheral border has a width (d2−d3)/2 in the hole 24 having the diameter d2. The coin bar 90b (not shown) can be inserted to the position of the second bottom 28b. The region at the inner side of the second bottom 28b is formed into a substantially circular shape, and the region has an area at which the coin bar 90a (refer to FIG. 2) can pass.

As shown in FIG. 3(c), the third bottom 28c is a region of the hole 24 having a diameter d3, and has a substantially circular shape. Then, the coin bar 90a (refer to FIG. 2) can be inserted to the position of the third bottom 28c.

(Description of Operation of the Coin Bar Unpacking Apparatus)

Next, the operation of the coin bar unpacking apparatus 10 is described with reference to FIG. 4. FIG. 4 is a cross-sectional view along the XZ plane of the coin bar unpacking apparatus 10 in a state in which the coin bar 90a is unpacked.

If the pressing force applied in the arrow F direction shown in FIG. 2 is applied to the coin bar 90a, as shown in FIG. 4, since the movement of the coin bar 90a is restricted by the abutting section 27 and the pressure reception section 32, the pressing force applied in the arrow F direction (refer to FIG. 2) is concentrated at a point 32a which is on a side opposite to the point where the coin bar 90a abuts against the pressure reception section 32. If a pressing force is further applied, a tensile force of the film 92 for packing the coin bar 90a cannot withstand the force of moving the coin bar 90a to the Z axis negative side, and at the point 32a, the film 92 breaks.

Specifically, if the pressing force in the direction substantially orthogonal to the direction of the coin bar 90a is applied to one end, which is not inserted into the hole 24, of the coin bar 90a, a point to which the pressing force is applied acts as a point of application. Then, the point where the coin bar 90a abuts against the hole 24 at the abutting section 27 acts as a fulcrum. Furthermore, the point where the coin bar 90a abuts against the wrapping member 30 at the pressure reception section 32 acts as a point of action. As a result, a force in a direction to bend the coin bar 90a can be applied to the coin bar 90a. Since the breakage of the film 92 at the point 32a is transmitted in the direction orthogonal to the direction of the coin bar 90a (substantially in the Z axis negative direction), the film 92 breaks along the Z axis. The coin bar 90a then bends, and the side surface thereof moves to a position where the coin bar 90a collides with the outer surface of the housing 20, i.e., the colliding section 26.

In this way, the coin bar 90a can be unpacked at the position of the wrapping member 30. Then, since the breakage of the film 92 is finished when the coin bar slice 90x collides with the colliding section 26, the coin bar slice 90x and the coin bar slice 90y are connected by the residual film section 94 which is not broken. If the housing 20 has sufficient strength to withstand the wrapping of the coin bar 90a, the wrapping member 30 may not be installed.

The direction of the pressing force applied to the coin bar 90a may not always be constant. Then, if the direction of the pressing force is changed, the position of the abutting section 27 changes to a position corresponding to the direction of the pressing force on the inner wall of the hole 24. As the position of the abutting section 27 changes, the position of the pressure reception section 32 also changes.

The depth at which the coin bar 90a is inserted is not always constant. As the depth at which the coin bar 90a is inserted changes, the position of the abutting section 27 changes accordingly on the inner wall of the hole 24. As the position of the abutting section 27 changes, the position of the pressure reception section 32 also changes.

In order to effectively transmit the pressing force to the coin bar 90a and easily unpack the coin bar 90a, it is desirable not to move the position of the abutting section 27 formed by the tip of the coin bar 90a abutting against the hole 24 due to occurrence of slippage or the like until the coin bar 90a is unpacked. Therefore, it is desirable that the inner wall of the hole 24, particularly an area where the abutting section 27 may be formed, has an anti-slip effect, for example, by making a satin finish or the like.

Although a case in which the coin bar 90a is unpacked is described as an example, the unpacking mechanism is the same for the coin bars 90b and 90c (not shown).

### Description of Modification of Embodiment

In the above-described embodiment, the hole 24 has a configuration in which an cross-sectional area decreases stepwise towards the back side (the X axis negative direction side), but the configuration of the hole 24 is not limited thereto.

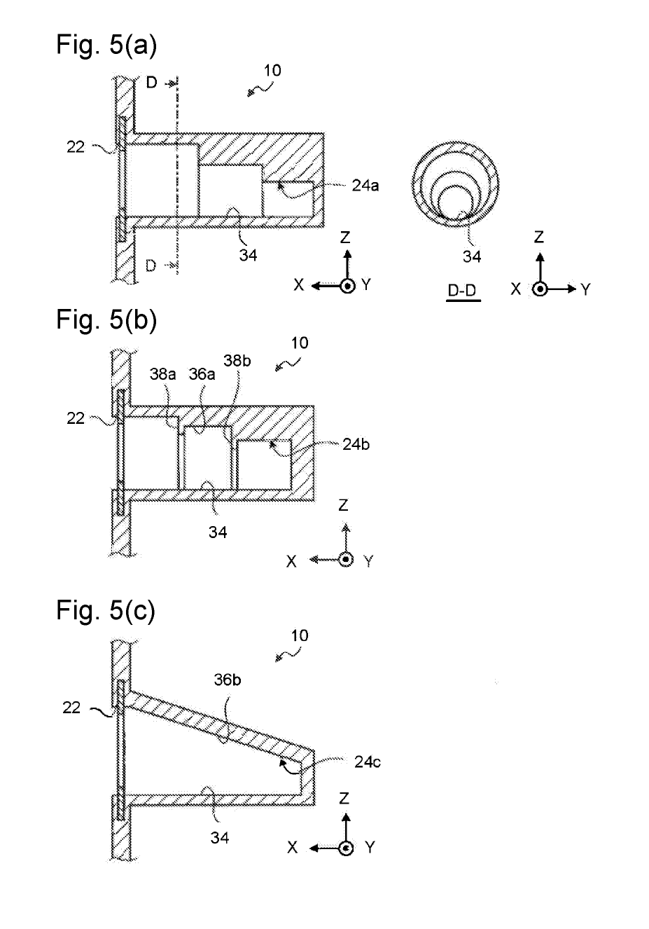

FIG. 5 is cross-sectional views along XZ plane and YZ plane illustrating a modification of the hole 24 of the coin bar unpacking apparatus 10. In particular, FIG. 5(a) shows an example in which a hole 24a is formed without setting the steps on an inner wall lower portion 34 which is the inner wall on the Z axis negative direction side with respect to the hole 24 described in the embodiment. FIG. 5 (b) shows an example in which a hole 24b is formed in such a manner that ribs 38a and 38b are formed on an inner wall upper portion 36a with respect to the hole 24a. FIG. 5 (c) shows an example in which a hole 24c is formed in such a manner that an cross-sectional area of the inner wall upper portion 36b which is the inner wall on the Z axis positive direction side decreases in a conical shape towards the back side with respect to the hole 24a.

According to the hole 24a in FIG. 5 (a), as shown in a D-D cross-sectional view (i.e., cross-sectional view along YZ plane) obtained by cutting the cross-sectional view along the XZ plane in FIG. 5 (a) along a cutting line D-D, there is no step on the inner wall lower portion 34. Therefore, when inserting the coin bar 90 from the opening 22, the coin bar 90 can be inserted to the back of the hole 24a while abutting against the inner wall lower portion 34. Therefore, the coin bar 90 can be easily inserted.

According to the hole 24b in FIG. 5(b), since there is no step on the inner wall lower portion 34, it becomes easier to insert the coin bar 90 when inserting the coin bar 90 from the opening 22. Furthermore, according to the hole 24b, since ribs 38a and 38b are formed on the inner wall upper portion 36a, it is possible to reduce the weight of the housing 20 as compared with the hole 24 described above.

According to the hole 24c in FIG. 5(c), since the cross-sectional area of the hole 24c becomes smaller in the conical shape towards the back side, when inserting the coin bar 90 from the opening 22, the coin bar 90 can be inserted into the back of the hole 24c while abutting against the inner wall upper portion 36b or the inner wall lower portion 34. Therefore, it becomes further easier to insert the coin bar 90.

The coin bar unpacking apparatus 10 may be manufactured as shown in FIG. 1 and placed in the vicinity of a POS terminal or the like in a retail store, or the coin bar unpacking apparatus 10 may be built in a POS terminal, a tape cutter, a drawer device, a register table, or the like.

As described above, according to the coin bar unpacking apparatus 10, by applying the pressing force in the direction substantially orthogonal to the direction of the coin bar 90 to one end of the coin bar 90 which is not inserted into the hole 24 while the coin bar 90 is being inserted into the hole 24 from the opening 22, the tip of the coin bar 90 abuts against the position of the hole 24 in response to the direction of the pressing force to form the abutting section 27 for restricting the movement of the coin bar 90 in a direction other than the insertion direction. Then, the pressure reception section 32 which receives the pressing force is formed in the vicinity of the opening 22 at a position in response to the direction of the pressing force to the one end of the coin bar 90 and the position of the abutting section 27. The formed abutting section 27 acts as the fulcrum to enable the force corresponding to the applied pressing force to the pressure reception section 32 acting as the point of action, thereby tearing up the film 92 packing the coin bar 90. Therefore, the coin bar 90 can be easily unpacked. Since the coin bar unpacking apparatus 10 does not use parts such as a cutter that need to be replaced, there is no need to replace the parts.

According to the coin bar unpacking apparatus 10, the hole 24 has a shape in which the cross-sectional area thereof decreases stepwise towards the back side. Therefore, when the coin bars 90 (90a, 90b, 90c) having different diameters are inserted into the hole 24, the coin bars 90 are definitely inserted to the positions corresponding to the diameters thereof, and the abutting sections 27 can be formed.

According to the coin bar unpacking apparatus 10, the hole 24c has such a shape that the cross-sectional area decreases in the conical shape towards the back side. Therefore, when the coin bars 90a, 90b and 90c having different diameters are inserted into the hole 24c, it is easy to insert the coin bars 90 while abutting against the wall surface of the hole 24c. In FIG. 5(c), the inner wall upper portion 36b and the inner wall lower portion 34 may be inverted such that the inner wall upper portion 36b has a shape parallel to the X axis, and the inner wall lower portion 34 is inclined downwards along the X axis positive direction side. With the hole 24c, the coin bar slice 90y (refer to FIG. 4) remaining in the hole 24c slides down to the X axis positive direction side, i.e., the opening 22 side, and in this way, it is easy to take out the coin bar slice 90y after unpacking.

### Second Embodiment

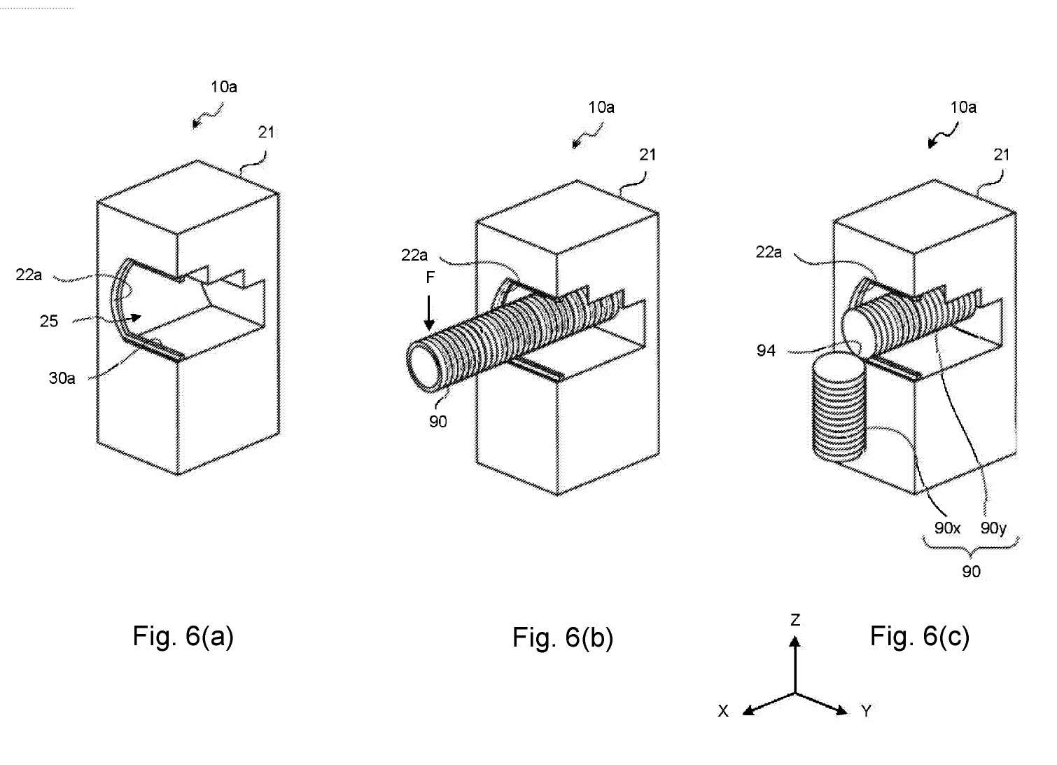

Next, a second embodiment is described. FIG. 6(a) is a perspective view externally illustrating a coin bar unpacking apparatus 10a according to a second embodiment, FIG. 6(b) is a perspective view externally illustrating a state in which a coin bar 90 is inserted into the coin bar unpacking apparatus 10a, and FIG. 6(c) is a perspective view externally illustrating a state in which the coin bar 90 is unpacked with the coin bar unpacking apparatus 10a.

As shown in FIG. 6 (a), the coin bar unpacking apparatus 10a has an opening 22a and a hole 25 continuous to the opening 22a on a housing 21. The opening 22a is formed so as to have an opening also on the Y axis positive direction side of the housing 21, in addition to the opening on the X axis positive direction side of the housing 21. In the opening 22a, the coin bar 90 can be inserted in the hole 25 from the side surface side of the coin bar 90, i.e., the Y axis positive direction side in addition to from the X axis positive direction side.

The inner shape of the hole 25 is similar to the hole 24 described in the first embodiment. In other words, the coin bars 90 having different diameters can be inserted to depths corresponding to the coin bars 90, respectively. A wrapping member 30a is installed at an end on the X axis positive direction side of the opening 22a. The wrapping member 30a is U-shaped according to the shape of the opening 22a. The inner shape of the hole 25 may be the shape shown in FIG. 5.

For example, the coin bar 90 is inserted in the hole 25 as shown in FIG. 6 (b). By applying the pressing force from the arrow F direction to the inserted coin bar 90 as in the first embodiment, the coin bar unpacking apparatus 10a is provided with the abutting section 27 and the pressure reception section 32, which are not shown in FIG. 6. Then, the coin bar 90 is unpacked as shown in FIG. 6 (c). Like the first embodiment, the unpacked coin bar 90 is divided into the coin bar slice 90x and the coin bar slice 90y. The coin bar slice 90x and the coin bar slice 90y are connected by the residual film section 94.

The unpacked coin bar 90 is taken out through the opening 22a. At that time, the coin bar 90 may be taken out from the X axis positive direction side or taken out from the Y axis positive direction side. In FIG. 6(a), the hole 25 is formed in a horizontal direction extending along the Y axis from the opening formed on the Y axis positive direction side, but the hole 25 may be inclined in such a manner that it becomes lower towards the Y axis negative side. As a result, the coin bar 90 inserted into the hole 25 slides down in the Y axis negative direction side along the inclination, and thus, the inserted coin bar 90 hardly slides down from the opening in the Y axis positive direction side. A surface of the hole 25 that is continuous to the opening on the X axis positive direction side of the housing 21 may be an inclined surface that becomes lower towards the X axis positive direction side. In this case, as described above, since the coin bar slice 90y remaining in the hole 25 slides down in the X axis positive direction side, it is possible to easily take out the coin bar slice 90y after unpacking.

As described above, according to the coin bar unpacking apparatus 10a, the opening 22a is formed in such a manner that the coin bar 90 can be inserted into the hole 25 even from the side surface. Therefore, the insertion of the coin bar 90 becomes further easier. Furthermore, according to the coin bar unpacking apparatus 10a, it is possible to easily clean the cut end of the film 92 accumulated in the hole 25, dust accumulated in the hole 25, or the like.

### Third Embodiment

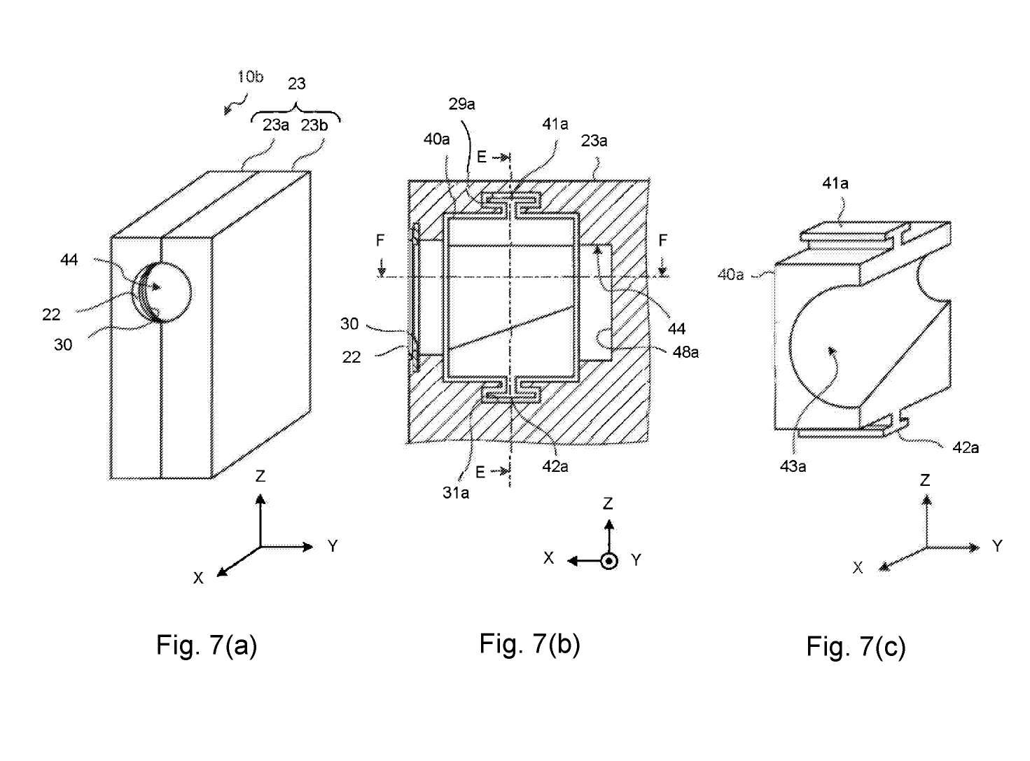

Next, the third embodiment is described. FIG. 7(a) is a perspective view externally illustrating a coin bar unpacking apparatus 10b according to the third embodiment. FIG. 7(b) is a cross-sectional view along XZ plane of the coin bar unpacking apparatus 10b. FIG. 7(c) is a perspective view externally illustrating the coin bar pressing frame 40a.

As shown in FIG. 7(a), the coin bar unpacking apparatus 10b has a hole 44 having the opening 22 in a housing 23 having a substantially rectangular parallelepiped shape. The housing 23 is formed by joining a housing 23a and a housing 23b by bonding, screwing or the like. The opening 22 is formed at a junction between the housing 23a and the housing 23b, and has a shape (for example, a substantially circular shape) into which the coin bar 90 can be inserted. The hole 44 is formed towards the inside of the housing 23 from the opening 22, and the coin bar 90 can be inserted at a depth corresponding to the coin bar 90 (not shown), for example, until the position corresponding to about the half of the length of the coin bar 90. The specific internal structure of the hole 44 is described later. For the sake of the following description, a XYZ coordinate system is set in such a manner that an extending direction of the hole 44 of the coin bar unpacking apparatus 10b is set as X axis, a width direction of the coin bar unpacking apparatus 10b is set as Y axis, and a height direction of the coin bar unpacking apparatus 10b is set as Z axis.

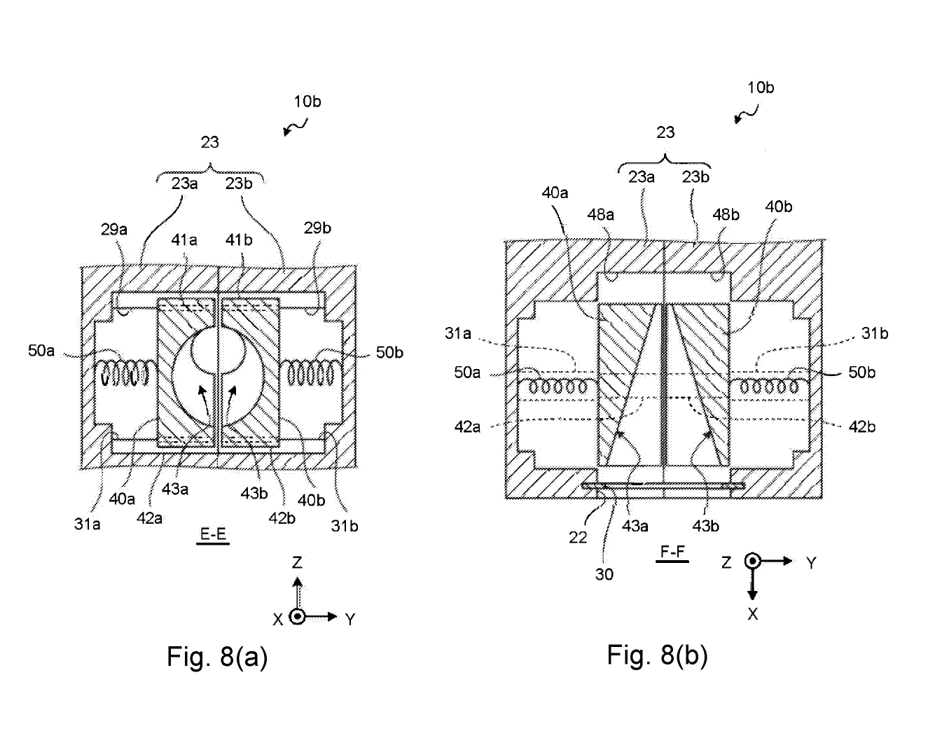

As shown in FIG. 7 (b), the coin bar pressing frame 40a is provided inside the housing 23a. On the housing 23b side, the coin bar pressing frame 40b (refer to FIG. 8) is provided. The coin bar pressing frame 40a and the coin bar pressing frame 40b have the same shape and are installed to face each other.

The coin bar pressing frame 40a has an inner wall 43a as shown in FIG. 7(c). The inner wall 43a has a concave shape in such a manner that a diameter thereof gradually decreases from the X axis positive side to the X axis negative side. The shape of the inner wall 43a is the same as that of the above hole 24c (refer to FIG. 5(c)), and the inserted coin bar 90 is guided to a position corresponding to the diameter of the coin bar 90. The coin bar pressing frame 40b (refer to FIG. 8(a)) provided inside the housing 23b also has an inner wall 43b (refer to FIG. 8 (a)) having the same shape.

A sliding section 41a and a sliding section 42a are formed at upper and lower positions in the Z axis direction of the coin bar pressing frame 40a. The sliding section 41a and the sliding section 42a are respectively fitted in grooves 29a and 31a formed in the housing 23a. The sliding sections 41a and 42a function as guide members in the housing 23a when the coin bar pressing frame 40a slides in the Y axis direction.

At the deepest position of the hole 44, a bottom surface 48a is formed. The wrapping member 30 is provided in the vicinity of the opening 22 similarly to the coin bar unpacking apparatus 10 of the first embodiment.

In the hole 44, the coin bar 90 is inserted from the opening 22. Then, a tip of the inserted coin bar 90 is inserted to the position of a bottom surface 48a. At this time, when a pressing force is applied to one end of the coin bar 90 which is not inserted into the hole 44, the tip of the coin bar 90 inserted into the hole 44 abuts against the inner wall of the hole 44 to form the abutting section 27 (refer to FIG. 4). At this time, the pressure reception section 32 (refer to FIG. 4) is formed at the end of the wrapping member 30 when unpacking the coin bar 90.

Next, the internal structure of the hole 44 is described with reference to FIG. 8. FIG. 8 (a) is a cross-sectional view along YZ plane of the coin bar unpacking apparatus 10b, that is, across-sectional view taken along a line E-E in FIG. 7(b). FIG. 8 (b) is a cross-sectional view along XY plane of a coin bar unpacking apparatus 10b, that is a cross-sectional view taken along a line F-F in FIG. 7(b).

As shown in FIG. 8(a) and FIG. 8(b), the coin bar pressing frame 40a and the coin bar pressing frame 40b are arranged with the inner wall 43a and the inner wall 43b facing each other. The coin bar pressing frames 40a and 40b are examples of movable walls, respectively.

As shown in FIG. 8(a), a spring 50a, which is an elastic member, is connected between the housing 23a and the surface on the Y axis negative side of the coin bar pressing frame 40a. A spring 50b, which is an elastic member, is connected between the housing 23b and the surface on the Y axis positive side of the coin bar pressing frame 40b. The springs 50a and 50b are, for example, metal springs. Then, the coin bar pressing frame 40a and the coin bar pressing frame 40b are respectively pressurized by the spring 50a and the spring 50b to keep a state of abutting against each other.

The sliding section 41a and the sliding section 42a provided in the coin bar pressing frame 40a are fitted in the grooves 29a and 31a as described above. Then, the sliding sections 41a and 42a are guided by the grooves 29a and 31a such that the coin bar pressing frame 40a can slide in the Y axis direction. A sliding section 41b and a sliding section 42b provided on the coin bar pressing frame 40b are fitted in the grooves 29b and 31b, respectively. The sliding sections 41b and 42b are guided by the grooves 29b and 31b such that the coin bar pressing frame 40b can slide in the Y axis direction.

As shown in FIG. 8(b), the inner wall 43a of the coin bar pressing frame 40a and the inner wall 43b of the coin bar pressing frame 40b are formed in such a manner that the diameters thereof are gradually reduced towards the X axis negative direction. Then, if the coin bar 90 (not shown) is inserted from the opening 22, the coin bar 90 abuts against the inner wall 43a and the inner wall 43b, and moves towards the X axis negative side while applying a force in a spreading direction to the inner wall 43a and the inner wall 43b. At this time, the coin bar pressing frames 40a and 40b receive the elastic force of the springs 50a and 50b, respectively, and thus, the insertion of the coin bar 90 is guided.

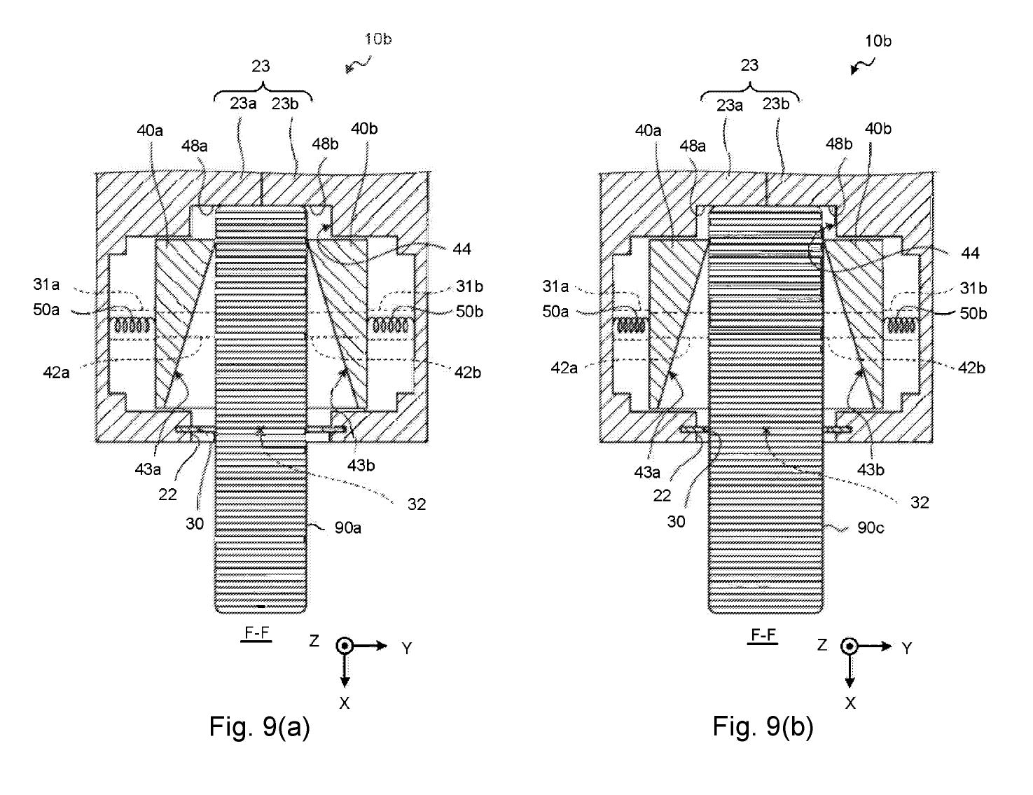

Next, with reference to FIG. 9, the operation when the coin bars 90a and 90c having different diameters are inserted into the coin bar unpacking apparatus 10b is described. FIG. 9(a) is a cross-sectional view along XY plane, that is, a cross-sectional view taken along a line F-F in FIG. 7(b), showing an inserted state of the thinner coin bar 90a to the coin bar unpacking apparatus 10b. FIG. 9 (b) is a cross-sectional view along XY plane, that is a cross-sectional view taken along a line F-F in FIG. 7 (b), showing an inserted state of the thicker coin bar 90c to the coin bar unpacking apparatus 10b.

As shown in FIG. 9 (a), when the thinner coin bar 90a is inserted into the coin bar unpacking apparatus 10b, the tip of the coin bar 90a moves to the inside of the housings 23a and 23b while abutting against the inner walls 43a and 43b. At this time, the coin bar 90a applies a pressing force to open the inner walls 43a and 43b in the Y axis direction. The coin bar pressing frame 40a is moved in the Y axis negative direction by the pressing force. At that time, the sliding sections 41a and 42a (refer to FIG. 7 (b)) provided at the upper and lower positions in the Z axis direction of the coin bar pressing frame 40a slide along the grooves 29a and 31a (refer to FIG. 8(a)) of the housing 23a. Therefore, the coin bar pressing frame 40a moves to the Y axis negative direction according to the insertion position of the coin bar 90a while maintaining the position thereof. Then, the coin bar pressing frame 40a is pressurized in the Y axis positive direction by the elastic force of the spring 50a. Therefore, the coin bar pressing frame 40a moves to a position where the pressing force in the Y axis negative direction by the coin bar 90a and the pressing force in the Y axis positive direction by the spring 50a are balanced.

Then, the coin bar pressing frame 40b having the inner wall 43b also moves to the housing 23b in the same manner as the coin bar pressing frame 40a. Specifically, the coin bar pressing frame 40b receives a pressing force to open in the Y axis positive direction as the coin bar 90a is inserted. At that time, the sliding sections 41b and 42b (refer to FIG. 8(a)) provided at the upper and lower positions in the Z axis direction of the coin bar pressing frame 40b slide along the grooves 29b and 31b (refer to FIG. 8(a)) of the housing 23b. Therefore, the coin bar pressing frame 40b moves to the Y axis positive direction according to the insertion position of the coin bar 90a while maintaining the position thereof. Then, the coin bar pressing frame 40b is pressurized in the Y axis negative direction by the elastic force of the spring 50b. Therefore, the coin bar pressing frame 40b moves to a position where the pressing force in the Y axis positive direction by the coin bar 90a and the pressing force in the Y axis negative direction by the spring 50b are balanced.

The tip of the inserted coin bar 90a reaches the positions of the bottom surfaces 48a and 48b of the hole 44. The bottom surface 48b is the bottom surface of the hole 44 which is formed on the housing 23b side. At this time, the inner wall 43a and the inner wall 43b are in a state of being spread apart from each other, meanwhile, a force in a direction to sandwich the coin bar 90a acts on the inner walls 43a and 43b from the springs 50a and 50b, and thus, the coin bar 90a is grasped by the coin bar pressing frames 40a and 40b without rattling.

When the coin bar 90a is in the state of being inserted into the position of the bottom surfaces 48a and 48b, as described in the first embodiment, a pressing force in a direction substantially orthogonal to the direction of the coin bar 90a, i.e., towards the substantially Z axis negative direction is applied to one end, which is not inserted into the hole 44, of the coin bar 90a. Then, the tip of the coin bar 90a abuts against the inner wall of the hole 44 to form the abutting section 27 (not shown in FIG. 9 (a)). A portion on the opening 22 side of the coin bar 90a then abuts against the wrapping member 30 to form the pressure reception section 32. In this way, when the pressing force is further applied in a state in which the abutting section 27 and the pressure reception section 32 are formed, the coin bar 90a is unpacked at a position corresponding to the abutting section 27 and the pressure reception section 32.

On the other hand, as shown in FIG. 9 (b), when the thicker coin bar 90c is inserted, the coin bar pressing frames 40a and 40b also operate similarly. In this case, since the coin bar 90c is thicker than the coin bar 90a, the amount of movement of the coin bar pressing frames 40a and 40b becomes larger than that in the case of FIG. 9 (a). However, even in this case, the tip of the coin bar 90c is inserted to the position of the bottom surfaces 48a and 48b. Then, as described above, when the pressing force in the direction substantially orthogonal to the direction of the coin bar 90c is applied to one end, which is not inserted into the hole 44, of the coin bar 90c, the abutting section 27 (not shown) and the pressure reception section 32 are formed, and the coin bar 90c is unpacked at a position corresponding to the abutting section 27 and the pressure reception section 32.

As described above, according to the coin bar unpacking apparatus 10b, when inserting the coin bar 90, the hole 44 is provided with the coin bar pressing frames 40a and 40b moving to positions corresponding to the diameter of the coin bar 90 while abutting against the coin bar 90. Therefore, it is possible to insert the tip of the coin bar 90 to the positions of the bottom surfaces 48a and 48b of the hole 44, regardless of the diameter of the coin bar 90 (90a, 90b, 90c). Therefore, since the length of a portion protruding from the opening 22 in the coin bar 90 inserted into the hole 44 is substantially equal regardless of the diameter of the coin bar 90, it is possible to unpack the coin bar 90 with substantially equal pressing force regardless of the diameter of the coin bar 90.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit of the invention. The accompanying claims and their equivalents are intended to cover such forms or modifications as would fall within the scope and spirit of the invention.

What is claimed is:

1. A coin bar unpacking apparatus, comprising:
a housing including an opening and a hole configured to accommodate a packed coin bar inserted through the opening, the hole extending in an insertion direction of packed coin bar and decreasing in diameter along the insertion direction such that a first diameter of the hole at a first location is greater than a second diameter of the hole at a second location that is farther from the opening than the first location,
wherein an inner surface of the housing at the second location restricts movement of the packed coin bar in a first direction when the packed coin bar is pressed against a rim of the opening in a second direction that is opposite to the first direction.

2. The coin bar unpacking apparatus according to claim 1, wherein
the hole diameter decreases in a step manner along the insertion direction.

3. The coin bar unpacking apparatus according to claim 1, wherein
the hole diameter decreases in a continuous manner along the insertion direction.

4. The coin bar unpacking apparatus according to claim 1, wherein the insertion direction is substantially perpendicular to a side face of the housing through which the opening is formed.

5. The coin bar unpacking apparatus according to claim 1, wherein
the hole is formed by movable walls that apply a compressive force towards a center longitudinal axis of the hole by spring members.

6. The coin bar unpacking apparatus according to claim 5, wherein
an end portion of hole along the insertion direction is at the second location and is formed by the inner surface of the housing.

7. The coin bar unpacking apparatus according to claim 1, wherein
the housing includes a first housing having a first opening and a first hole, and a second housing having a second opening and a second hole, and
the first housing is joined to the second housing such that the opening is formed from the first opening and the second opening, and the hole is formed from the first hole and the second hole.

8. The coin bar unpacking apparatus according to claim 1, wherein
a bottom portion of the hole extends horizontally and a top portion of the hole is sloped downwardly.

9. The coin bar unpacking apparatus according to claim 1, wherein
a top portion of the hole extends horizontally and a bottom portion of the hole is sloped upwardly.

10. A coin bar unpacking apparatus, comprising:
a housing including an opening and a hole configured to accommodate a packed coin bar inserted through the opening, the hole extending in an insertion direction of packed coin bar and decreasing in width along the insertion direction such that a first width of the hole at a first location is greater than a second width of the hole at a second location that is farther from the opening than the first location,
wherein an inner surface of the housing at the second location restricts movement of the packed coin bar in a first direction when the packed coin bar is pressed against a rim of the opening in a second direction that is opposite to the first direction.

11. The coin bar unpacking apparatus according to claim 10, wherein the hole has a circular cross-section and the width is equal to a diameter of the circular cross-section.

12. The coin bar unpacking apparatus according to claim 10, wherein the hole has a non-circular cross-section and the width is equal to a width of the non-circular cross-section along a direction that is transverse to the insertion direction.

13. The coin bar unpacking apparatus according to claim 10, wherein
the hole width decreases in a step manner along the insertion direction.

14. The coin bar unpacking apparatus according to claim 10, wherein
the hole width decreases in a continuous manner along the insertion direction.

15. The coin bar unpacking apparatus according to claim 10, wherein the insertion direction is substantially perpendicular to a side face of the housing through which the opening is formed.

16. The coin bar unpacking apparatus according to claim 10, wherein
the housing includes a first housing having a first opening and a first hole, and a second housing having a second opening and a second hole, and
the first housing is joined to the second housing such that the opening is formed from the first opening and the second opening, and the hole is formed from the first hole and the second hole.

17. The coin bar unpacking apparatus according to claim 10, wherein
the hole is formed by movable walls that apply a compressive force towards a center longitudinal axis of the hole by spring members.

18. The coin bar unpacking apparatus according to claim 17, wherein
an end portion of hole along the insertion direction is at the second location and is formed by the inner surface of the housing.

19. The coin bar unpacking apparatus according to claim 10, wherein
a bottom portion of the hole extends horizontally and a top portion of the hole is sloped downwardly.

20. The coin bar unpacking apparatus according to claim 10, wherein
a top portion of the hole extends horizontally and a bottom portion of the hole is sloped upwardly.
